(19) United States
(12) Patent Application Publication
(10) Pub. No.: US 2016/0360694 A1
(43) Pub. Date: Dec. 15, 2016

(54) PITCH CONTROL SYSTEM FOR RIDING MOWER CHUTE

(71) Applicant: Jimmie Smith, Jacksonville, FL (US)

(72) Inventor: Jimmie Smith, Jacksonville, FL (US)

(21) Appl. No.: 14/738,843

(22) Filed: Jun. 13, 2015

(51) Int. Cl. A01D 34/71; A01D 34/81

(52) U.S. Cl. CPC A01D 34/71; A01D 34/81

(57) ABSTRACT

A system for pivoting a discharge chute of a mower includes a cable attached at one end to a coupling at the top surface of a chute near the free end of the chute, trained on a pulley at a height above the height of the top surface of the chute, and attached at the other end to a handle. An operator can easily reach the handle and move it to a retainer, which releasably holds the handle. When the handle is in the retainer, the chute is forced to pivot to a raised (i.e., upright) position.

### FIELD OF THE INVENTION

This invention relates generally to riding mowers, and, more particularly, to a system for pivoting a discharge chute of a mower.

### BACKGROUND

Lawn mowers, particularly ride-on lawn mowers used by gardeners, have a cutting deck that houses one or more rotating blades. Grass clippings created by cutting action of the rotating blades are usually discharged through a discharge chute, often located on and extending from the right side of the deck. In some mowers, a torsion spring urges the chute in a downward, i.e., deployed, position. In other mowers, gravity maintains the discharge chute in the deployed position. In the deployed configuration, the discharge chute prevents bystanders and structures from being struck by objects propelled by the rotating blades.

The discharge chute extends outwardly several inches from the deck. Thus, when mowing next to walls, fences, trees, flower beds or other obstacles, the operator must proceed with the left side of the mower against the obstacle to prevent the chute from impacting the obstacle. Impact between the chute and the obstacle may damage either the chute, the obstacle or both. For example, impacting a tree, fence, gate or wall may damage the chute. Impacting flowers with the chute may damage the flowers. Having to re-orient the mower with the left side abutting or adjacent to the obstacle to avoid such impact is inconvenient, as it may require the operator to repeatedly change directions.

Additionally, many gate openings are not sufficiently wide to accommodate the deck and chute. Thus, an operator must stop the cutting blades and hold up the chute while the mower is driven through the gate opening. While a limber operator may be able to accomplish this maneuver unsafely on his own by leaning over and grabbing the chute with his hand, a typical operator may require an assistant to finesse the mower through a narrow gate opening. This too is inconvenient, and potentially very hazardous. An operator may fall from the mower, injure his hand and/or injure his back in grabbing the chute.

Similar problems arise when a mower is loaded onto a trailer for hauling. With the chute deployed, the mower cannot be positioned with its right side flush against the side of the trailer. If the left side of the mower is flush against the side of the trailer, then the chute occupies appreciable space in the trailer, which may prevent another mower or other equipment from being stored on the trailer side by side with the mower. Concomitantly, the chute tends to hang low and catch on any raised objects. When a mower is driven up a ramp onto a trailer, the ramp or trailer deck may catch the chute, damaging it.

The invention is directed to overcoming one or more of the problems and solving one or more of the needs as set forth above.

### SUMMARY OF THE INVENTION

To solve one or more of the problems set forth above an exemplary system for pivoting a discharge chute of a mower is provided. The mower has a seat, a control surface adjacent to the seat between the chute and the seat, and a cutting deck with a chute extending from a side of the cutting deck. The chute has a top surface, a joined end and a free end opposite the joined end. A pivot joint joins the joined end of the chute to the cutting deck. The pivot joint enables the chute to pivot between a raised (upright) position and a lowered position. The exemplary system includes a tether having a first end and an opposite second end. A coupling is attached to the top surface of the chute near the free end of the chute. The first end of the tether is attached to the coupling. A first pulley is attached (either moveably attached or fixedly attached) to the mower between the seat and the free end of the chute at a pulley height that is above a height of the top surface of the chute when the chute is in the lowered position. The tether is trained about the first pulley. A handle is attached to the second end of the tether. A retainer is attached to the control surface. The retainer has a holder for receiving and holding the handle. The handle is moveable to and removeable from the retainer. When the handle is moved to the retainer and held in the holder of the retainer, the tether pulls the coupling and causes the chute to pivot to the upright position. When the handle is removed from the retainer, the chute pivots from the raised position to the lowered position and the handle moves from the retainer towards the first pulley.

The coupling may comprise a bracket having a mounting base with a distal end and an opposite proximal end, and a tab extending outwardly from the mounting base near the distal end of the mounting base. The first end of the cable is attached to the tab.

The tether may be a cable, such as a coated cable and/or corrosion resistant cable.

The handle is moveable between a first handle position and a second handle position. When the handle is in the first handle position, the chute is in the lowered position. When the handle is in the second handle position, the chute is in the upright position. The retainer is at the second handle position.

In one embodiment, a second pulley is provided between the first pulley and the retainer. The tether is trained about the second pulley. The handle is moveable from the second pulley to the retainer. The second pulley may define the first handle position. Movement of the handle from the second pulley to the retainer causes the chute to pivot from a lowered to a raised (upright) position.

In one embodiment, the retainer has a pair of spaced apart hooked arms and the handle is a T-shaped handle. The T-shaped handle has a handgrip and an orthogonal neck. The handgrip has a handgrip length and the orthogonal neck has a neck width. The spaced apart hooked arms are spaced apart a distance that is greater than the neck width and less than the handgrip length.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a plan view of an exemplary mower equipped with a system for pivoting a discharge chute of a mower according to principles of the invention; and

FIG. 2 is a top perspective view of an exemplary mower equipped with a system for pivoting a discharge chute of a mower according to principles of the invention; and

FIG. 3 is a plan view of an exemplary system for pivoting a discharge chute of a mower, with the chute in a deployed configuration, according to principles of the invention; and

FIG. 4 is a front view of an exemplary system for pivoting a discharge chute of a mower, with the chute in a deployed configuration, according to principles of the invention; and

FIG. 5 is a perspective view of an exemplary system for pivoting a discharge chute of a mower, with the chute in a deployed configuration, according to principles of the invention; and

FIG. 6 is a plan view of an exemplary system for pivoting a discharge chute of a mower, with the chute in a raised configuration, according to principles of the invention; and

FIG. 7 is a front view of an exemplary system for pivoting a discharge chute of a mower, with the chute in a raised configuration, according to principles of the invention; and

FIG. 8 is a perspective view of an exemplary system for pivoting a discharge chute of a mower, with the chute in a raised configuration, according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

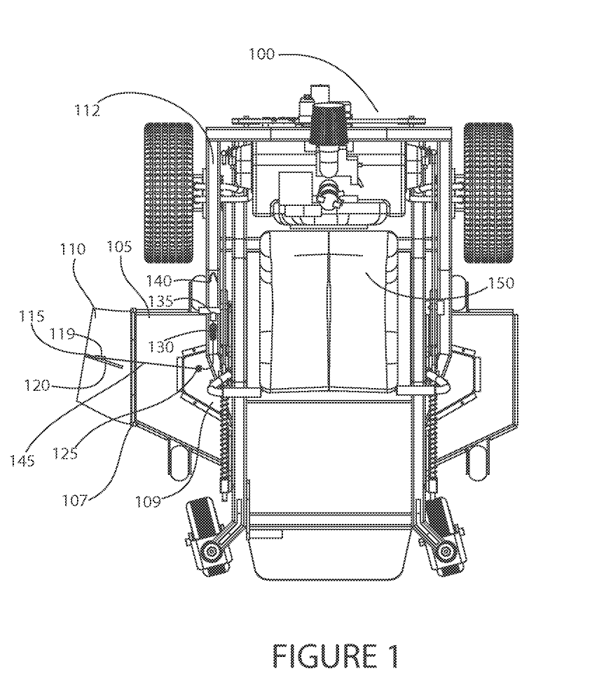

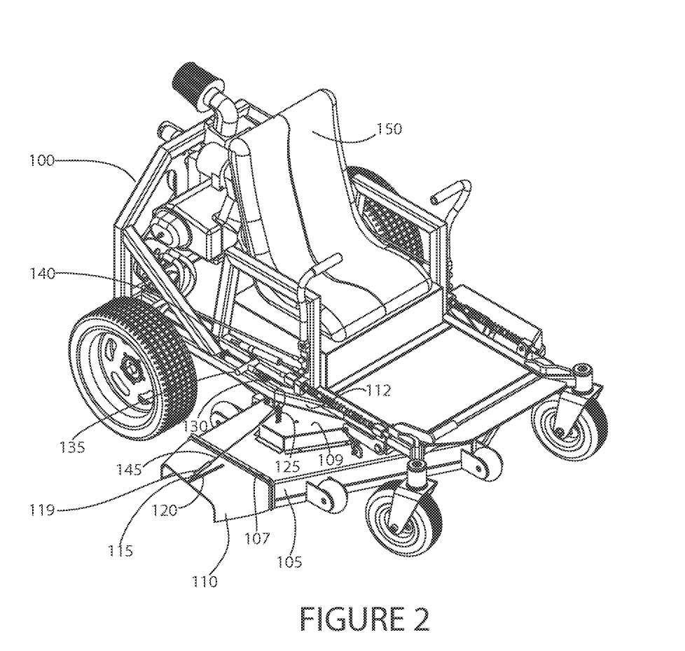

Referring to FIGS. 1 and 2, an exemplary mower equipped with a system for pivoting a discharge chute according to principles of the invention is conceptually illustrated. While a zero turn mower is depicted, the invention is not limited to such a mower. The invention may be applied to any riding mower with a chute.

The mower includes a cutting deck 105 that envelopes rotating cutting blades. The chute 110 is connected to the cutting deck by a pivoting joint 107 (e.g., a hinge). The chute 110 surrounds an opening in the cutting deck 105.

The pivoting joint 107 may or may not be spring biased. In a spring biased embodiment, the joint 107 may include a torsion spring or torsion bar that urges the chute 110 towards the deployed configuration. Alternatively, the chute may act under the influence of gravity, without a biasing spring or torsion bar. In such an embodiment, gravity urges the chute to the deployed configuration. In the deployed configuration (i.e., deployed position), the chute 110 is down and directs cuttings and other debris propelled by the cutting blades from the cutting deck 105 to the ground.

The mower 100 also includes a belt housing 109. The belt housing 109 contains and protects pulleys and belts that drive the rotating blades with the cutting deck 105. In the illustrated exemplary mower 100, the belt housing 109 is separate from and above the cutting deck 105. The invention is not limited to a riding mower with a belt housing or with any particular configuration of belt housing. The exemplary depicted mower 100 merely happens to have a belt housing 109. The top of the belt housing 109 is higher than the top surface of the chute 110. Consequently, pulling the cable 145 causes the chute 110 to pivot upright.

An operator sits in the seat 150. Controls are provided on control surfaces to the right side and left side of the seat 150. Controls for the pitch control systems according to principles of the invention are provided on the control surface 112, within easy reach of the operator, on the same side of the mower 100 as the cute 110, which, in the exemplary embodiment, is the right side.

The pitch control system according to principles of the invention includes a bracket 120 attached to the top of the chute 110, a first pulley 125, one or more optional additional pulleys 130, a handle 135 and a retaining hook 140. A tether, e.g., a cable 145, extends from the handle 135, over each pulley 125, 130, to the bracket 120. Each of these components, and their functions and configuration are discussed below. In operation, the handle 135 is pulled back by the operator and placed in the retaining hook 140 to pitch the chute 110 upright (i.e., pivot the chute 110 about the joint 107 from the deployed position to an upright position). When the operator releases the handle 135 from the retaining hook 140, the chute 110 falls back to the deployed position under the influence of a biasing spring or torsion bar and/or gravity.

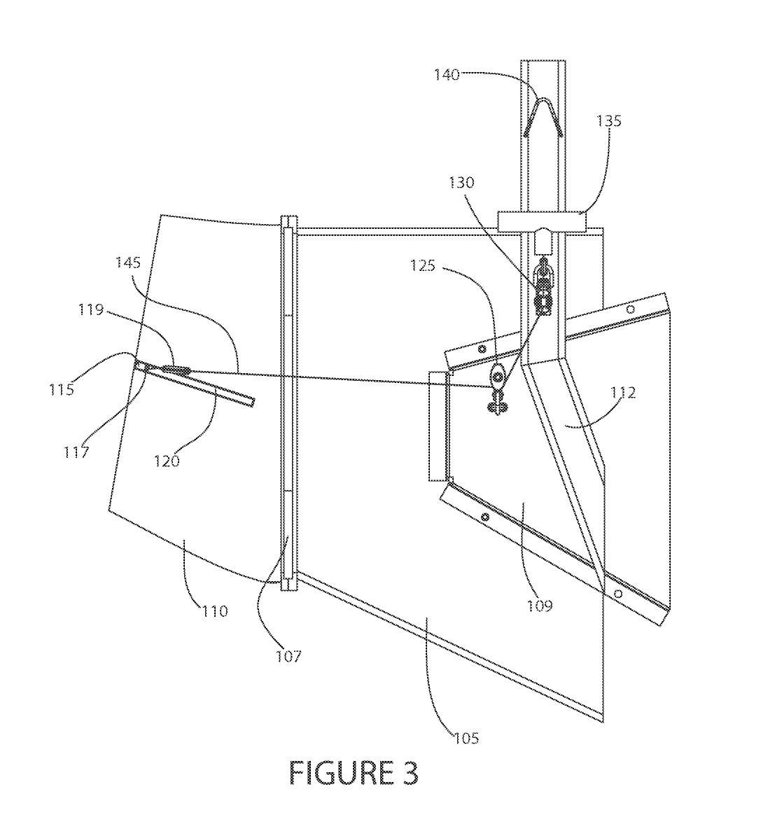

In FIGS. 3 through 5 the chute 110 is shown in the deployed configuration. The handle 135 is not pulled back to the retaining hook 140. Instead, the handle 135 is closer to the chute 110, allowing the chute 110 to fall to or remain in the deployed configuration.

The cable 145 is sized to extend from bracket 155 through the first pulley 125 and any additional pulley 130. The cable 145 is sized by pulling excess cable through the cable clamp 119. The cable 145 extends through tab 117 of the bracket 115. The clamp 119 grips a portion of the cable 145 extending to the tab 117 and a portion of the cable 145 extending from the tab 117. By increasing or decreasing the length of the portion of the cable 145 extending from the tab 117, the engaged length of the cable is adjusted. Such increase or decrease is accomplished by loosening screws on the cable clamp 119, adjusting the cable 145 relative to the tab 117, and then tightening the screws on the clamp 119.

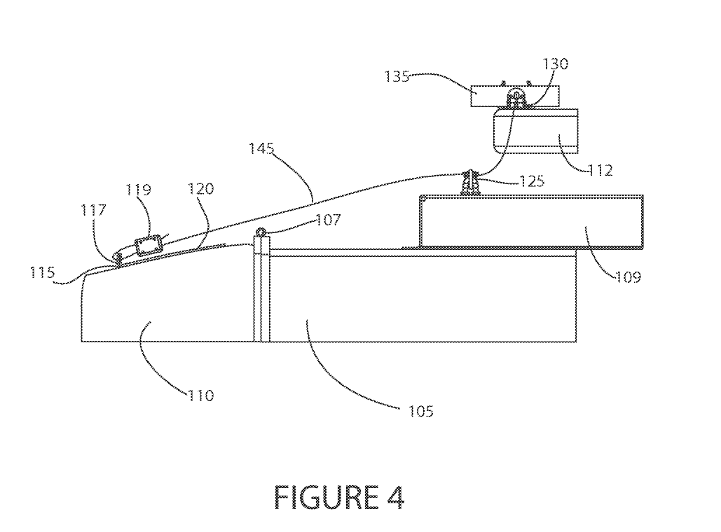

The tab 117 couples the cable 145 to the chute 110. As shown in FIG. 4, the tab 117 of the bracket 115 extends outwardly from the base 120 of the bracket 115. The tab 117 of the bracket 115 is attached to the base 120 of the bracket 115. The base 120 of the bracket 115 is mounted to the top side of the deployed chute 110. The tab 117 of the bracket 115 is positioned near the free end of the chute 110. The invention is not limited to the depicted L-shaped bracket 115, or any particular bracket. Other structures for coupling (i.e., couplers) an end of the cable to the top side of the chute 110 near the free end of the chute 110 may be utilized and comes within the spirit and scope of the invention.

At least one pulley 125 is provided between the bracket 115 and retaining hook 140, which is also between the free end of the chute and the seat of the mower. In the exemplary embodiment, two pulleys 125, 130 are provided. The pulley closest to the chute 110 should be at a height that is above the top surface of the chute 110, preferably at a height that is about the height of the bracket 115 when the chute is pivoted upright. By way of example, mounting the first pulley 125 to the belt housing 109 positions the first pulley 125 at a height above the top surface of the chute 110. The pulleys 125, 130 guide the cable so that the handle 135 is positioned alongside the seat 150, within reach of the operator. The pulleys 125, 130 may be mounted in a fixed position or may be moveably coupled. The particular type and configuration of pulleys may vary considerably without departing from the scope of the invention.

The handle 135 is moveable from a pulley 130 to the retaining clip 140. The distance between the retaining clip 140 and the pulley 130 closest to the retaining clip is the distance that the cable is pulled to pivot the chute 110 upwardly. This distance may vary depending upon the particular mower 100, chute 110 configuration, bracket 115 position and configuration, and pulley 130 position.

The cable is preferably durable, yet flexible, and weather resistant. Galvanized steel or stainless steel cable is preferred. However, cables comprised of other materials, including, but not limited to, cables with a corrosion resistant coating or sheath may be utilized.

A T-shaped handle 135 is illustrated. However, the invention is not limited to handle having a particular shape. Handles having other shapes may be utilized, so long as the retainer (i.e., retaining hook 140) will receive and retain the handle.

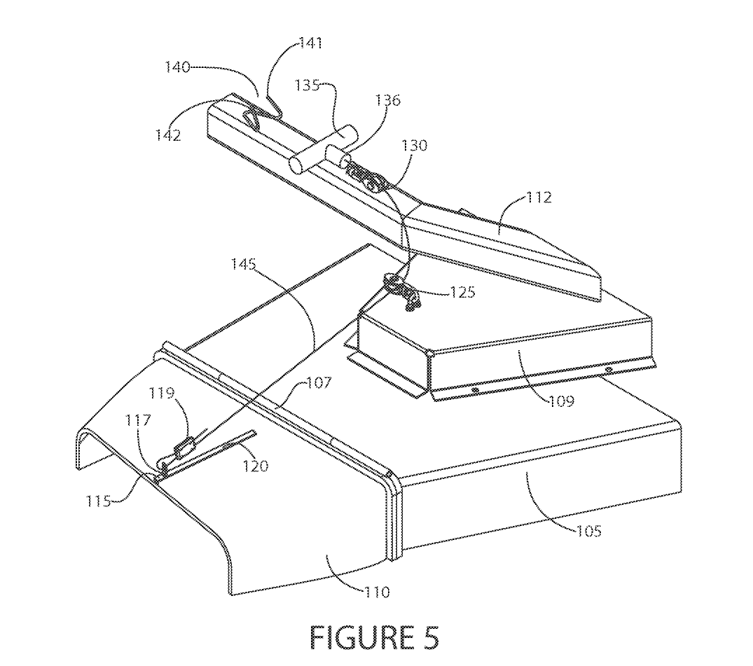

As shown in FIG. 5, the retaining hook 140 includes a pair of spaced apart hooked arms 141, 142. The space between the arms 141, 142 is less than the length of the handle 135, but greater than the width of the neck 136 of the handle 135.

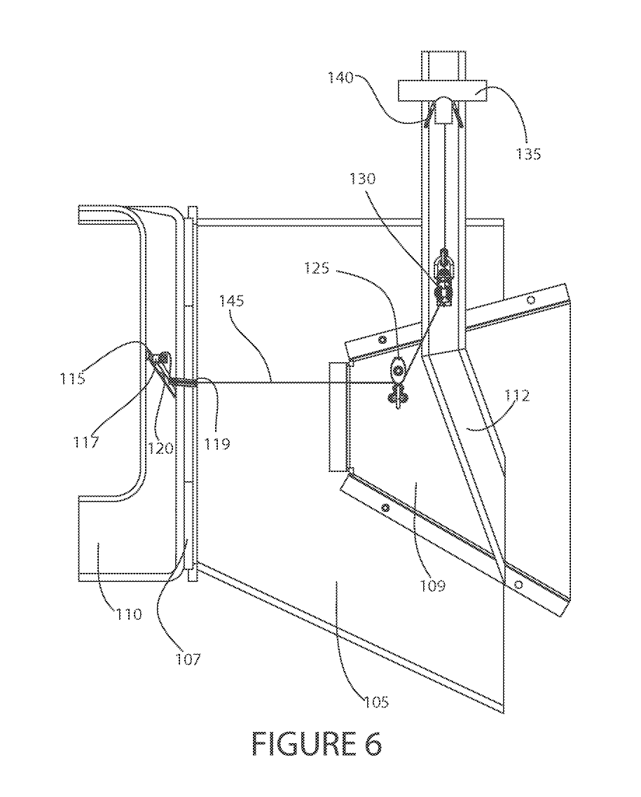

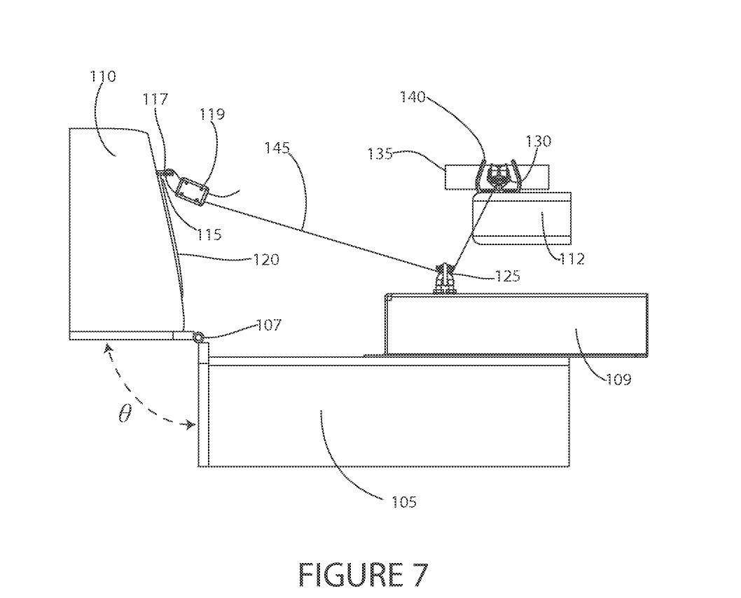

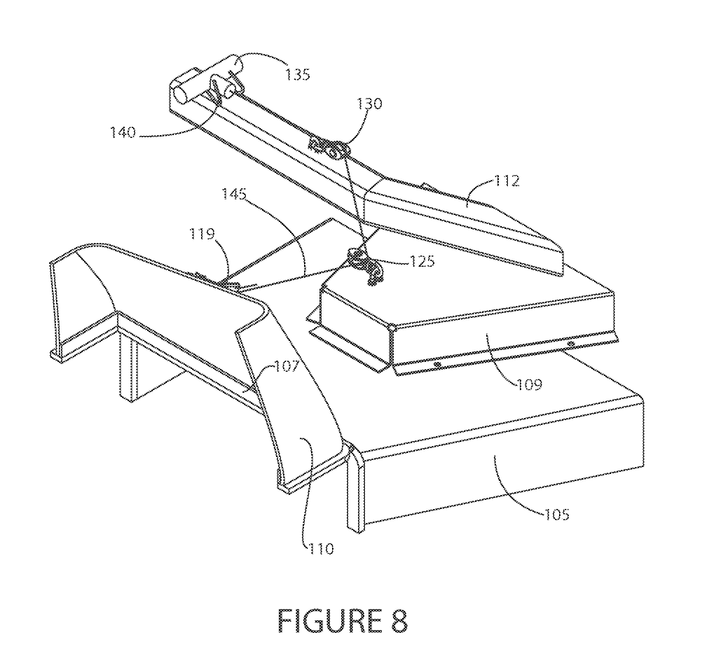

In FIGS. 6 through 8, various views of the exemplary system for pivoting a discharge chute 110 of a mower 100, with the chute 110 in a raised configuration, according to principles of the invention, are provided. The handle 135 has been pulled back to the retainer 140. The hooked arms 141, 142 of the retainer 140 engage (i.e., hold) the handle 135. While moving the handle 135 from the pulley 130 to the retainer 140, the cable pulls the bracket 115 towards pulley 125, thereby causing the chute 110 to pivot upwardly about the joint 107. In the upward position, the chute 110 poses less of an obstacle, providing substantially greater clearance along the right side of the mower 100.

In FIGS. 6 through 8, the angle θ is the angle of rotation (i.e., pivoting about joint 107) of the chute 110. The angle is preferably at least 90°. If the angle θ is acute, a substantial portion of the chute 110 may continue to extend outwardly from the side of the cutting deck 105. With an angle θ of at least 90°, the portion of the chute 110 extending outwardly from the cutting deck is reduced. Much of the chute 110 extends upwardly, rather than outwardly. If the angle θ appreciably exceeds 90°, the chute 110 may tip towards the operator. In this case, the chute 110 may not automatically return to the deployed position when the handle 135 is removed from the retainer 140, unless the joint 107 is spring biased. If the chute does not automatically return to the deployed position when the handle 135 is released, the operator may easily reach the free end of the chute 110 and urge (i.e., push) it towards the deployed position.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A system for pivoting a discharge chute of a mower comprising a seat, a control surface adjacent to the seat between the chute and the seat, a cutting deck with a chute extending from a side of the cutting deck, said chute having a top surface and a joined end and a free end opposite the joined end, and a pivot joint joining the joined end of the chute to the cutting deck, the pivot joint enabling the chute to pivot between a raised position and a lowered position, said system comprising:
a tether having a first end and an opposite second end;
a coupling attached to the top surface of the chute near the free end of the chute, the first end of the tether attached to the coupling;
a first pulley attached to the mower between the seat and the free end of the chute at a pulley height that is above a height of the top surface of the chute when the chute is in the lowered position, the tether being trained about the first pulley;
a handle attached to the second end of the tether;
a retainer attached to the control surface, the retainer having a holder for receiving and holding the handle, the handle being moveable to and removable from the retainer, and, when the handle is moved to the retainer and held in the holder of the retainer, the tether pulling the coupling and causing the chute to pivot to the upright position, and, when the handle is removed from the retainer, the chute pivoting from the raised position to the lowered position and the handle moving from the retainer towards the first pulley.

2. The system for pivoting a discharge chute of a mower according to claim 1, the coupling comprising a bracket having a mounting base with a distal end and an opposite proximal end, and a tab extending outwardly from the mounting base near the distal end of the mounting base, the first end of the cable attached to the tab.

3. The system for pivoting a discharge chute of a mower according to claim 1, the tether being a cable.

4. The system for pivoting a discharge chute of a mower according to claim 3, the cable being corrosion resistant.

5. The system for pivoting a discharge chute of a mower according to claim 3, the cable being coated.

6. The system for pivoting a discharge chute of a mower according to claim 1, the first pulley being moveably attached to the mower.

7. The system for pivoting a discharge chute of a mower according to claim 1, the first pulley being fixedly attached to the mower.

8. The system for pivoting a discharge chute of a mower according to claim 1, the handle being moveable between a first handle position and a second handle position, and when the handle is in the first handle position the chute is in the lowered position, and when the handle is in the second handle position the chute is in the upright position.

9. The system for pivoting a discharge chute of a mower according to claim 8, the retainer being at the second handle position.

10. The system for pivoting a discharge chute of a mower according to claim 1, further comprising a second pulley between the first pulley and the retainer, the tether trained about the second pulley, the handle being moveable from the second pulley to the retainer.

11. The system for pivoting a discharge chute of a mower according to claim 10, movement of the handle from the second pulley to the retainer causing the chute to pivot from a lowered to a raised position.

12. The system for pivoting a discharge chute of a mower according to claim 1, the retainer comprising a pair of spaced apart hooked arms.

13. The system for pivoting a discharge chute of a mower according to claim 12, the handle comprising a T-shaped handle.

14. The system for pivoting a discharge chute of a mower according to claim 13, the T-shaped handle comprising a handgrip and an orthogonal neck.

15. The system for pivoting a discharge chute of a mower according to claim 14, the handgrip having a handgrip length and the orthogonal neck having a neck width, and the spaced apart hooked arms being spaced apart a distance that is greater than the neck width and less than the handgrip length.

16. The system for pivoting a discharge chute of a mower according to claim 1, the coupling comprising a bracket having a mounting base with a distal end and an opposite proximal end, and a tab extending outwardly from the mounting base near the distal end of the mounting base, the first end of the cable attached to the tab; and
the tether being a corrosion resistant cable.

17. The system for pivoting a discharge chute of a mower according to claim 16, the handle being moveable between a first handle position and a second handle position, and when the handle is in the first handle position the chute is in the lowered position, and when the handle is in the second handle position the chute is in the upright position; and
the retainer being at the second handle position.

18. The system for pivoting a discharge chute of a mower according to claim 17, further comprising a second pulley between the first pulley and the retainer, the tether trained about the second pulley, the handle being moveable from the second pulley to the retainer.

19. The system for pivoting a discharge chute of a mower according to claim 18, the second pulley being at the first handle position.

20. The system for pivoting a discharge chute of a mower according to claim 19, the retainer comprising a pair of spaced apart hooked arms and the handle comprising a T-shaped handle.
